(19) United States
(12) Patent Application Publication
(10) Pub. No.: US 2023/0325464 A1
(43) Pub. Date: Oct. 12, 2023

(54) HPC FRAMEWORK FOR ACCELERATING SPARSE CHOLESKY FACTORIZATION ON FPGAS

(71) Applicant: ARIZONA BOARD OF REGENTS ON BEHALF OF ARIZONA STATE UNIVERSITY, Scottsdale, AZ (US)

(72) Inventors: Erfan Bank Tavakoli, Tempe, AZ (US); Fengbo Ren, Tempe, AZ (US); Michael Riera, Hialeah, FL (US); Masudul Quraishi, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 18/133,302

(22) Filed: Apr. 11, 2023

Related U.S. Application Data
(60) Provisional application No. 63/329,706, filed on Apr. 11, 2022.

(51) Int. Cl. G06F 17/16

(52) U.S. Cl. CPC G06F 17/16

(57) ABSTRACT

A high-performance computing (HPC) framework for accelerating sparse Cholesky factorization on field-programmable gate arrays (FPGAs) is provided. The proposed framework includes an FPGA kernel implementing a throughput-optimized hardware architecture for accelerating a supernodal multifrontal algorithm for sparse Cholesky factorization. The proposed framework further includes a host program implementing a novel scheduling algorithm for finding the optimal execution order of supernode computations for an elimination tree on the FPGA to eliminate the need for off-chip memory access for storing intermediate results. Moreover, the proposed scheduling algorithm minimizes on-chip memory requirements for buffering intermediate results by resolving the dependency of parent nodes in an elimination tree through temporal parallelism.

### RELATED APPLICATION

This application claims priority to, and the benefit of, U.S. Provisional Application No. 63/329,706, entitled “An HPC Framework for Accelerating Sparse Cholesky Factorization On FPGAs,” and filed Apr. 11, 2022, which is hereby incorporated by reference in its entirety.

### FIELD OF THE DISCLOSURE

The present disclosure relates to acceleration of processes in high-performance computing (HPC).

### BACKGROUND

Solving large symmetric sparse linear systems using sparse Cholesky factorization plays a pivotal role in many scientific computing and high-performance computing (HPC) applications. Example applications of sparse Cholesky factorization are provided below
Signal processing: Cholesky factorization is used in adaptive filtering algorithms for noise cancellation and system identification.
Finance: Cholesky factorization is applied in portfolio optimization and risk management.
Engineering: Cholesky factorization is used in structural analysis for linear finite element analysis.
Computer graphics: Cholesky factorization is used in mesh deformation and smoothing.
Optimization: Cholesky factorization is used in convex optimization problems, such as quadratic programming.
Machine learning: Cholesky factorization is used in various machine learning algorithms, such as Gaussian processes for regression and classification problems.
Statistics: Cholesky factorization is used in the estimation of covariance matrices, regression analysis, and the calculation of Mahalanobis distances.

Nonetheless, the existing computational solutions to sparse Cholesky factorization based on central processing units (CPUs) and graphical processing units (GPUs) suffer from very limited performance for to two primary reasons. First, sparse Cholesky factorization algorithms (e.g., multifrontal algorithms) are recursive and have complex data dependencies for sequentially updating nodes in an elimination tree based on the intermediate results from previous iterations. For the sake of data locality and computational performance, an algorithm-tailored buffering scheme for efficiently storing the intermediate results must be employed for computing a sparse Cholesky factorization. Unfortunately, the deep memory hierarchy and fixed hardware architecture of CPUs and GPUs can hardly be adapted to efficiently implement such an algorithm-tailored buffering scheme. Consequently, CPU- and GPU-based solutions suffer from poor cache locality and often require frequent off-chip memory access for computing sparse Cholesky factorization, greatly limiting their performance.

Second, sparse Cholesky factorization algorithms involve complex operations (e.g., inverse square root) that are often computed using approximation algorithms (e.g., the Newton-Raphson method) that are also iterative and have strong loop-carried data dependency. Unfortunately, the legacy hardware architectures of CPUs and GPUs, while being able to exploit massive spatial parallelism, lack the capability to exploit the temporal/pipeline parallelism that is critical to resolving such loop-carried data dependency, which results in long loop initiation intervals causing further reduced performance.

In addition to the limited performance issue of CPU- and GPU-based sparse Cholesky factorization solutions for HPC applications, these solutions suffer from very high energy consumption due to high runtime (i.e., low performance) and power consumption of CPUs and GPUs (e.g., 135 W thermal design power for Intel Xeon Processor E5-2637 v3 and 250 W for NVIDIA V100 TENSOR CORE GPU). The high energy consumption of CPUs and GPUs in HPC data centers has received significant attention due to its high economic, environmental, and performance costs.

### SUMMARY

A high-performance computing (HPC) framework for accelerating sparse Cholesky factorization on field-programmable gate arrays (FPGAs) is provided. The proposed framework includes an FPGA kernel implementing a throughput-optimized hardware architecture for accelerating a supernodal multifrontal algorithm for sparse Cholesky factorization. The framework further includes a host program implementing a novel scheduling algorithm for finding the optimal execution order of supernode computations for an elimination tree on the FPGA to eliminate the need for off-chip memory access for storing intermediate results. Moreover, the proposed scheduling algorithm minimizes on-chip memory requirements for buffering intermediate results by resolving the dependency of parent nodes in an elimination tree through temporal parallelism.

Evaluation results for factorizing a set of sparse matrices in various sizes from SuiteSparse Matrix Collection show that the proposed framework implemented on an Intel Stratix 10 GX FPGA development board achieves on geometric average 5.5× and 9.7× higher performance and 10.3× and 24.7× lower energy consumption than implementations of CHOLMOD on an Intel Xeon E5-2637 CPU and an NVIDIA V100 GPU, respectively.

An exemplary embodiment provides an accelerator. The accelerator includes an FPGA kernel configured to accelerate a supernodal multifrontal algorithm for sparse Cholesky factorization and a host program configured to schedule operations of the supernodal multifrontal algorithm.

According to various embodiments, a computer system for Cholesky factorization is presented. The computer system includes: a field-programmable gate array (FPGA), the FPGA comprising an FPGA hardware architecture comprising a plurality of hardware processing elements, the FPGA configured to perform kernel operations comprising: performing a supernodal multifrontal algorithm for Cholesky factorization of a matrix, wherein the supernodal multifrontal algorithm for Cholesky factorization comprises factorize and update operations performed by the processing elements, and providing the Cholesky factorization of the matrix; and an electronic processor, the electronic processor communicatively coupled to the FPGA, the electronic processor implementing a host program, the host program configured to perform host operations comprising: identifying dependencies among computation nodes in an elimination tree derived from the matrix, and scheduling the processing elements to perform the factorize and update operations, using temporal parallelism, based on the dependencies.

Various optional features of the above computer system embodiments include the following. The computer system may implement the Cholesky factorization of the matrix for one of: signal processing, wherein the Cholesky factorization is implemented in an adaptive filtering algorithm, finance, wherein the Cholesky factorization is implemented in portfolio optimization or risk management, engineering, wherein the Cholesky factorization is implemented in structural analysis, computer graphics, wherein the Cholesky factorization is implemented in mesh deformation or smoothing, optimization, wherein the Cholesky factorization is implemented in convex optimization, machine learning, wherein the Cholesky factorization is implemented in a machine learning algorithm, or statistics, wherein the Cholesky factorization is implemented in the estimation of a covariance matrix, a regression analysis, or a calculation of a Mahalanobis distance. The electronic processor may include a central processing unit (CPU), wherein the CPU is communicatively coupled to the FPGA via a bus. Each hardware processing element may include: vector addition and matrix extension hardware modules responsible for the update operation; and sqrt, vector division, outer product, and vector subtraction hardware modules responsible for the factorize operation. The computer system may avoid off-chip memory access for intermediate data in performing the supernodal multifrontal algorithm for Cholesky factorization. The plurality of processing elements may be communicatively coupled to each-other via at least one first-in-first-out (FIFO) channel. The computer system may further include: a respective load module for each of the processing elements, wherein each processing element is communicatively coupled to its respective load module via at least one FIFO channel; and a respective store module for each of the processing elements, wherein each processing element is communicatively coupled to its respective store module via at least one FIFO channel. Depths of the FIFO channels may be determined by an offline compiler. The scheduling the processing elements to perform the factorize and update operations may include: assigning, to each processing element, an update operation for a parent node immediately after a factorize operation for a child node. The matrix may be sparse.

According to various embodiments, a method of Cholesky factorization is provided. The method is implemented by: a field-programmable gate array (FPGA), the FPGA comprising an FPGA hardware architecture comprising a plurality of hardware processing elements, and an electronic processor, the electronic processor communicatively coupled to the FPGA, the electronic processor implementing a host program, wherein the method includes: performing, by the FPGA, a supernodal multifrontal algorithm for Cholesky factorization of a matrix, wherein the supernodal multifrontal algorithm for Cholesky factorization comprises factorize and update operations performed by the processing elements; identifying, by the host program, dependencies among computation nodes in an elimination tree derived from the matrix; scheduling, by the host program, the processing elements to perform the factorize and update operations, using temporal parallelism, based on the dependencies; and providing the Cholesky factorization of the matrix.

Various optional features of the above method embodiments include the following. The method may further include implementing the Cholesky factorization of the matrix for one of: signal processing, wherein the Cholesky factorization is implemented in an adaptive filtering algorithm, finance, wherein the Cholesky factorization is implemented in portfolio optimization or risk management, engineering, wherein the Cholesky factorization is implemented in structural analysis, computer graphics, wherein the Cholesky factorization is implemented in mesh deformation or smoothing, optimization, wherein the Cholesky factorization is implemented in convex optimization, machine learning, wherein the Cholesky factorization is implemented in a machine learning algorithm, or statistics, wherein the Cholesky factorization is implemented in the estimation of a covariance matrix, a regression analysis, or a calculation of a Mahalanobis distance. The electronic processor may include a central processing unit (CPU), wherein the CPU is communicatively coupled to the FPGA via a bus. Each hardware processing element may include: vector addition and matrix extension hardware modules responsible for the update operation; and sqrt, vector division, outer product, and vector subtraction hardware modules responsible for the factorize operation. The method may avoid off-chip memory access for intermediate data in performing the supernodal multifrontal algorithm for Cholesky factorization. The plurality of processing elements may be communicatively coupled to each-other via at least one first-in-first-out (FIFO) channel. The method may be further implemented using: a respective load module for each of the processing elements, wherein each processing element is communicatively coupled to its respective load module via at least one FIFO channel; and a respective store module for each of the processing elements, wherein each processing element is communicatively coupled to its respective store module via at least one FIFO channel. The method may further include determining, by an offline compiler, depths of the FIFO channels. The scheduling the processing elements to perform the factorize and update operations may include: assigning, to each processing element, an update operation for a parent node immediately after a factorize operation for a child node. The matrix may be sparse.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1A illustrates the nonzero pattern of an example matrix L.

FIG. 1B illustrates an elimination tree of the matrix L of FIG. 1A.

FIG. 1C illustrates the supernodal elimination tree of FIG. 1B.

FIG. 2 shows a high-level block diagram of hardware architecture according to embodiments described herein, including six modules: two processing elements (PEs), two load, and two store modules.

FIG. 3 shows a high-level block diagram of each PE.

FIG. 4 shows an example of the extend operation at line 7 of Algorithm 1 and how update matrix U is extended and stored on Q_{U}.

FIG. 5 illustrates an output of a scheduling algorithm for the supernodal elimination tree in FIG. 1C.

FIG. 6 shows the performance improvement of the proposed framework over central processing unit (CPU) and graphical processing unit (GPU) implementations for corresponding the matrix.

FIG. 7 shows the energy consumption reduction factor of the proposed framework over the CPU and GPU implementations for the corresponding matrix.

FIG. 8 is a block diagram of a computer system suitable for implementing the proposed framework according to embodiments disclosed herein.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Field-programmable gate arrays (FPGAs) are being deployed as an emerging accelerator in data centers, offering an alternative solution to accelerating sparse Cholesky factorization for HPC applications. An FPGA is a farm of configurable hardware resources whose functionality and interconnection can be redefined at run-time by programming its configuration memory. A state-of-the-art FPGA carries an enormous amount of fine- and coarse-grained logic, computation, memory, and I/O resources. Upon the reconfiguration of these resources, an FPGA can implement any custom hardware architecture to accelerate algorithms with both performance and energy efficiency gains.

Specifically, the fine-grained logic resources and the abundant on-chip memory and register resources on FPGA devices can be used to implement the customized buffering scheme tailored to a given sparse Cholesky factorization algorithm to allow efficient storage of intermediate results and data movement among and within processing elements (PEs) with no off-chip memory access required. Furthermore, the hardware flexibility of an FPGA allows its reconfigurable resources to compose not only spatial but also temporal/pipeline parallelism both at a fine granularity and on a massive scale to best resolve the complex loop-carried data dependency that exists in sparse Cholesky factorization algorithms to minimize loop initiation intervals for improved performance.

FPGAs have lower energy consumption than CPUs and GPUs due to their lower runtime and power consumption. However, a framework has yet to be developed which can take advantage of FPGAs to accelerate sparse Cholesky factorization.

A high-performance computing (HPC) framework for accelerating sparse Cholesky factorization on field-programmable gate arrays (FPGAs) is provided. The proposed framework includes an FPGA kernel implementing a throughput-optimized hardware architecture for accelerating a supernodal multifrontal algorithm for sparse Cholesky factorization. The proposed framework further includes a host program implementing a novel scheduling algorithm for finding the optimal execution order of supernode computations for an elimination tree on the FPGA to eliminate the need for off-chip memory access for storing intermediate results. Moreover, the proposed scheduling algorithm minimizes on-chip memory requirements for buffering intermediate results by resolving the dependency of parent nodes in an elimination tree through temporal parallelism.

Evaluation results for factorizing a set of sparse matrices in various sizes from SuiteSparse Matrix Collection show that the proposed framework implemented on an Intel Stratix 10 GX FPGA development board achieves on average 5.5× and 9.7× higher performance and 10.3× and 24.7× lower energy consumption than implementations of CHOLMOD on an Intel Xeon E5-2637 CPU and an NVIDIA V100 GPU, respectively.

### I. Introduction

So far, there has been limited work for accelerating sparse Cholesky factorization on FPGAs. The limitations of the existing works are three-fold. First, the existing works adopt either a left-looking or a multifrontal algorithm in their implementations. These algorithms are less optimized in terms of memory access and computational complexity than the supernodal multifrontal algorithm for sparse Cholesky factorization. Second, the existing work based on the multifrontal algorithm fails to provide a scheduling algorithm for ordering and assigning the computation of different nodes in an elimination tree. The lack of a scheduling algorithm ignores the dependency among different nodes in an elimination tree, which inevitably demands frequent off-chip memory access and increases the size of on-chip memory required to load and store intermediate results. Third, the FPGA accelerator architecture proposed for the left-looking algorithm does not allow on-chip communication among different PEs, which enforces a large amount of off-chip memory access to occur for transferring intermediate results among PEs.

Traditional FPGA design is at the hardware description language (HDL) level, which is hard to be adopted by software and application developers in the HPC community. In recent years, high-level synthesis (HLS) technology that auto-generates HDL codes from high-level programming languages (e.g., C/C++, OpenCL, MATLAB, etc.) is becoming increasingly mainstream and makes FPGA computing a viable solution for HPC. However, new challenges also arise in the new HLS-based FPGA design flow, such as how to precisely define and optimize hardware architectures in a software-defined fashion and how to construct efficient computation pipelines for data flow processing using a memory-compute-based programming model. FPGA computing is currently an active area of research, and many questions are yet to be answered.

This disclosure proposes FSCHOL, an HPC framework for accelerating sparse Cholesky factorization on FPGAs. In some embodiments, the FSCHOL framework may be OpenCL-based. Other embodiments may be based on or implemented with other programming languages and systems. The proposed FSCHOL framework consists of an FPGA kernel implementing an energy-efficient and throughput-optimized hardware architecture and a host program implementing a novel scheduling algorithm. The supernodal multifrontal algorithm is adopted, which requires much less memory access and features lower computational complexity than the left-looking and the multifrontal algorithm used in existing works. This is critical to more efficient hardware mapping and improved performance.

Moreover, a memory-optimized scheduling algorithm is proposed for the host program for provisioning the execution of the supernodal multifrontal Cholesky factorization, and potentially all elimination-tree-based multifrontal methods, on an FPGA device. The scheduling algorithm identifies the dependency among computation nodes in an elimination tree and correspondingly arranges their computation order on the FPGA device to avoid off-chip memory access as well as to minimize the on-chip memory requirements for storing intermediate results. This is key to enabling data locality, thereby improving both computational performance and energy efficiency.

Finally, the proposed OpenCL-based FPGA kernel architecture enables pipelined on-chip transfers of intermediate results among processing elements (PEs) by utilizing first-in-first-out (FIFO) channels to eliminate undesired off-chip memory accesses by working in coordination with the scheduling algorithm running on the host side.

The contributions of this disclosure are summarized as follows.
An end-to-end OpenCL-based HPC framework is proposed for accelerating sparse Cholesky factorization on FPGAs, consisting of both an energy-efficient and deeply pipelined FPGA kernel for accelerating the supernodal multifrontal algorithm and a scheduling algorithm in the host program for eliminating the off-chip memory access and minimizing the on-chip memory requirements of the FPGA kernel for handling intermediate results.
The proposed FPGA hardware architecture is parameterized and scalable.

A method is proposed for determining the optimized architectural parameters for maximizing the run-time performance given a suitable FPGA board.
The proposed scheduling algorithm can be potentially applied to all elimination-tree-based multifrontal algorithms, including both the multifrontal and the supernodal multifrontal methods, for relaxing the memory constraints of an accelerator device (e.g., an FPGA or a GPU) in a host-accelerator computing model.
The performance and energy efficiency of FSCHOL is evaluated based on an Intel Stratix 10 GX FPGA development board and compared with CHOLMOD, a state-of-the-art library for sparse Cholesky factorization, running on an Intel Xeon E5-2637 CPU and an NVIDIA V100 TENSOR CORE GPU, respectively, for factorizing the nd3k, Trefethen 20000b, smt, thread, pdb1HYS, and nd24k matrices selected from SuiteSparse Matrix Collection. The evaluation results show that the proposed FSCHOL solution has on average 5.5× and 19.7× higher performance and 10.3× and 24.7× lower energy consumption than the CPU and GPU implementation of CHOLMOD, respectively.
FSCHOL is compared with the state-of-the-art FPGA design for running nd3k, Trefethen 20000b, and nd24k benchmarks. The evaluation results show that FSCHOL improves the technology-node-normalized performance on average by 11.7× for accelerating sparse Cholesky factorization on FPGAs over the reference method by completely eliminating off-chip memory access via software-hardware co-design.

### II. Cholesky Factorization

Cholesky factorization is an efficient method for decomposing a symmetric positive-definite matrix (A) into the product of a lower triangular matrix and its transpose (L×L^{T}). In many real-life science and engineering applications, matrix A is sparse. One of the significant methods for sparse matrix factorization was introducing multifrontal Cholesky factorization.

The multifrontal method reorganizes the overall factorization of a sparse matrix into a sequence of partial factorizations of smaller dense matrices. The main feature of the multifrontal method is that the update contributions from a factor column i(L(:i)) to the remaining submatrix are computed and accumulated with contributions from other factor columns before the updates are performed. Therefore, this method reduces the number of memory accesses and operations compared to left or right-looking algorithms.

The main concepts in the multifrontal method are an elimination tree, frontal and update matrices (denoted by F and U, respectively), and an extended-add operation. The elimination tree of the matrix L is defined as a tree structure with n nodes such that node P is the parent of node C if and only if the first subdiagonal nonzero element at column C is located at row P.

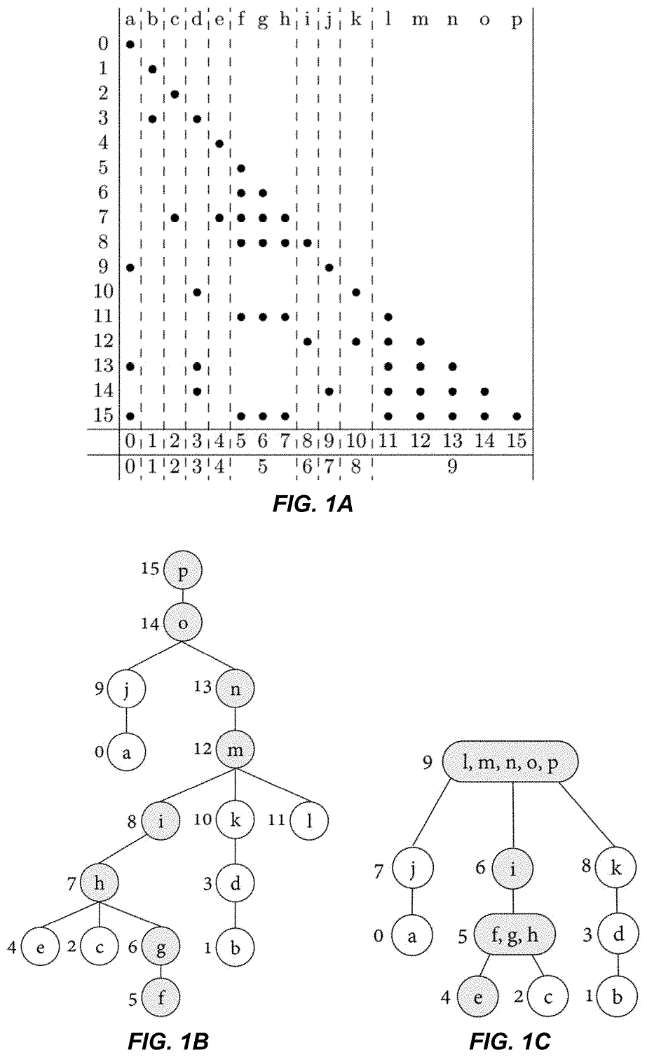

FIG. 1A illustrates the nonzero pattern of an example matrix L. FIG. 1B illustrates an elimination tree of the matrix L of FIG. 1A. If the critical path is defined as the longest path of nodes from the first to the top level of the elimination tree (e.g., filled nodes in FIG. 1B), the number of nodes in the critical path determines the maximum amount of dependency among nodes to be resolved.

A practical improvement to the multifrontal method is the use of supernodes. A supernode is a group of columns (i.e., nodes in the elimination tree) if they can be treated as one computational unit in the course of sparse Cholesky factorization. If the sparsity structure (i.e., nonzero patterns) of column j is defined as Struct(L(:,j)), the set of contiguous columns {j,j+1, . . . , j+} constitutes a supernode if Struct(L(:,k))=Struct(L(:,k+1)) U{k}.

FIG. 1C illustrates the supernodal elimination tree of FIG. 1 B. Algorithm 1 describes the sparse Cholesky factorization using the supernodal multifrontal method. In Algorithm 1, the notation nonzeros(V) is equivalent to the dense form (i.e., nonzero elements) of sparse vector V. Also, this notation represents the extend-add operation that adds two matrices with different dimensions by extending the smaller matrix with zeros. Comparing the critical path of the two methods, the node dependency is reduced. Moreover, Algorithm 1 introduces more parallelism in each outer loop iteration. Additionally, since the update matrix is generated per supernode rather than a node, the number of operations and memory accesses is reduced.

Algorithm 1: The supernodal multifrontal Cholesky factorization [5]

| 1 | for | each supernode S in increasing order of first columnn | |
|---|---|---|---|
| | \| | subscript do | |
| 2 | \| | Let S = {j, j + 1, . . . , j + t}; | |
| 3 | \| | Let j + t, i₁, . . . , iᵣ be the locations of nonzero elements in | |
| | \| | L(:, j + t); | |
| 4 | \| \| \| \| \| \| \| \| \| | ${F}_{S} = [ \begin{matrix}{a}_{j , j} & {a}_{j , j + 1} & … & {a}_{j , j + t} & {a}_{j , {i}_{1}} & … & {a}_{j , {i}_{r}} \\ {a}_{j + 1 , j} & {a}_{j + 1 , j + 1} & … & {a}_{j + 1 , j + t} & {a}_{j + 1 , {i}_{1}} & … & {a}_{j + 1 , {i}_{r}} \\ ⋮ & ⋮ & … & ⋮ & ⋮ & … & ⋮ \\ {a}_{j + t , j} & {a}_{j + t , j + 1} & … & {a}_{j + t , j + t} & {a}_{j + i , {i}_{1}} & … & {a}_{j + t , {i}_{r}} \\ {a}_{{i}_{1} , j} & {a}_{{i}_{1} , j + 1} & … & {a}_{{i}_{1} , j + t} & 0 & … & 0 \\ ⋮ & ⋮ & … & ⋮ & ⋮ & … & ⋮ \\ {a}_{{i}_{r} , j} & {a}_{{i}_{r} , j + 1} & … & {a}_{{i}_{r} , j + t} & 0 & … & 0\end{matrix} ] ;$ | |
| 5 | \| | nchildren := no. of children of S in supernodal elimination | |
| | \| | tree; | |
| 6 | \| | for | C from 1 to nchildren do |
| 7 | \| | \| | F_{S} = F_{S} ⊕ U; // update (S, C) |
| 8 | \| | end | |
| | \| | /* start of factorize(S) */ | |
| 9 | \| | for i from 0 to t do | |
| 10 | \| | \| | nonzeros(L(:, j + i)) = F_{S} (i :, i)/\sqrt{F_{S}(i, i)}; |
| 11 | \| | end | |

| | | |
|---|---|---|
| 12 | \| \| \| \| | ${U}_{S} = {F}_{S} ( t + 2 : , t + 2 : ) - [ \begin{matrix}{l}_{{i}_{1} , j + t} \\ ⋮ \\ {l}_{{i}_{r} , j + t}\end{matrix} ] [ {l}_{{i}_{1} , j + t} … {l}_{{i}_{r} , j + c} ] ;$ |
| | \| | /* end of factorize(S) */ |
| 13 | end | |

### III. FSCHOL Framework Design

The FSCHOL framework consists of two parts: The FPGA kernel and the host program running on the CPU. The kernel code implemented on the FPGA accelerator performs computationally intensive tasks. On the host side, the OpenCL API supports efficient management and scheduling of tasks running on the FPGA.

A. Hardware Architecture of the FPGA Kernel
1. Architectural Overview

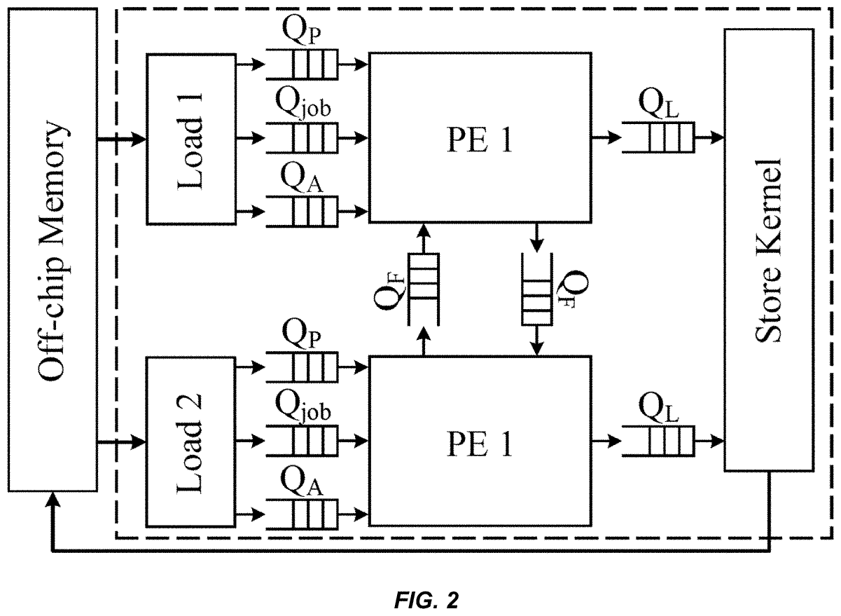

FIG. 2 shows a high-level block diagram of FSCHOL's hardware architecture, including six modules: two processing elements (PEs), two load, and two store modules. The PEs are responsible for computations, while load and store modules read and write input and output data from/to off-chip memory, respectively. All modules process data in a pipelined and vectorized fashion. PEs are connected to load and store modules via FIFO channels. Also, PEs utilize FIFOs to send and receive intermediate results to/from each other. Separating load/store modules from PEs and connecting them using a FIFO helps compensate for the difference between the off-chip memory bandwidth and the data processing throughput.

When the data processing throughput does not match the available off-chip memory bandwidth, and loading and storing primary input and output data happen in the same module that the data are being processed, the load and store operations would be stalled for the computation units. When the depth of the FIFO channels is optimized by the offline compiler, the load and store modules are able to continuously read and write data from/to the off-chip memory and write and read them to/from the channels, respectively. For each supernode, in addition to several consecutive columns of input matrix A depending on the size of the supernode, a PE needs configuration information on how to process the assigned supernode (job). The job information is set by the scheduling algorithm in the host program. Therefore, channels Q_{A} and Q_{job} are used to send the elements of matrix A and the job information, respectively. Channel Q_{P} is used to send the Boolean elements of the pattern matrix to PEs for the extend-add operation which the details are discussed in Section III-A.3. Channel Q_{L} sends the consecutive columns of factor matrix L of the corresponding processed supernode from a PE to the store module. Channels Q_{F} transmit the intermediate value of matrix F among PEs.
2. Load/Store Modules

Each load module iterates over the number of jobs that are assigned by the scheduling algorithm. First, the load module sends a data structure containing the configuration bits of the assigned job described in Table I. When a supernode S is assigned to a PE, S needs to be updated by all of its children according to lines 6-8 of Algorithm 1. Bit job. up determines whether S is updated by any of its children. If not, the load module reads input data from off-chip memory and write them to Q_{A} to be consumed by a PE. Store modules read the output data from PEs and send them to the off-chip memory as soon as a vector of factor matrix L is ready.

TABLE I
Configuration of bits of a job

| Attribute | Description | Type |
|---|---|---|
| job.up | supernode is partially updated | Boolean |
| job.last_c | Supernode is going to be updated by its last child | |
| job.F_rd | intermediate matrix F should be read from inter- | |
| | module FIFO | |
| job.F_wr | intermediate matrix F should be written from inter- | |
| | module FIFO | |
| job.U_rd | update matrix U should be read from FIFO | |

3. Processing Element (PE)

Based on Algorithm 1, two major operations are defined in each outer loop iteration: update and factorize. Operation update (S, C) (line 7 of Algorithm 1) updates the frontal matrix of supernode S(F_{S}) using the update matrix of its child supernode C(U_{C}). Operation factorize(S) (lines 9-12 of Algorithm 1) produces t+1 columns of factor matrix L and the update matrix of supernode S(U_{S}).

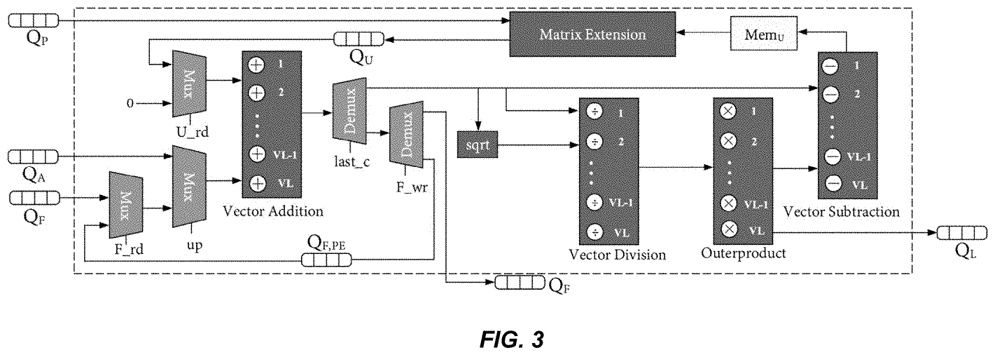

FIG. 3 shows a high-level block diagram of each PE. Modules Vector Addition and Matrix Extension are responsible for operation update and modules Sqrt, Vector Division, Outer Product, and Vector Subtraction perform operation factorize. For each scheduled job, a PE performs one update and one factorize operation (depending on the update status of F_{S}) in a pipelined and vectorized fashion.

When there is no available update matrix to update the frontal matrix of supernode S, intermediate (i.e., partially updated) values of F_{S} are stored to complete the update process (the for loop at lines 9-11 of Algorithm 1) later. Storage units for storing intermediate results inside each PE include RAM Mem_{U} for the update matrix, FIFO channel Q_{U} for the extended matrix update matrix, and FIFO channel Q_{F,PE} for the partially updated frontal matrix. Two inter-module FIFO channels are used to send and receive the intermediate matrix F(Q_{F}) among PEs whenever necessary.

For each job, PE starts by reading the configuration bits to control the multiplexers. Vectors V_{U} and V_{F} are defined to represent a vector with size VL of matrices F and U, respectively. If job. up is not set, node S is not updated by any of its children, and its factor vector V_{F} was not initialized with the values of matrix A as described in line 4 of Algorithm 1. Therefore, vector V_{F} is initialized by input data from Q_{A}. If node S is already updated, depending on the value of job. F_rd, V_{F} reads its value from Q_{F} or Q_{F,PE}. According to Table I, if job. F_rd is set, it shows that the intermediate values of matrix F as the result of a previous update of supernode S by one of its other children are stored at the inter-module FIFO Q_{F,PE}; otherwise they are stored at intra-module FIFO Q_{F}. If node S does not have any child, there is no update matrix to update node S. Therefore, U_{rd} determines whether vector V_{U} should be initialized by zeros (when there is no child) or by the values stored at Q_{U}. After loading vectors V_{U} and V_{F} with the corresponding values, they are added in parallel, and the output is stored at V_{F}.

After adding vectors V_{U} and V_{F}, a PE decides whether to store the results or feed V_{F} to the pipeline for the factorize(S) operation. As described in Table I, bit job.last_c defines whether node S is ready to be factorized. If it is not set, PE stores vector V_{F} in FIFO Q_{F} or Q_{F,PE} depending on the value of job. F_wr. If it is set, the PE takes the square root of the first t+1 diagonal elements of F_{S} (f_{1,1}, f_{2,2}, f_{t+1,t+1}) and divides the superdiagonal elements of F_{S} by the square root value. The PE uses elements lᵢ_{_{1,}}ⱼ₊ₜ, lᵢ_{_{2,}}ⱼ₊ₜ₊₁, . . . , lᵢ_{_{r,}}_{j+c} for the consequent outer product operation. Moreover, update matrix U_{S} is computed as describe at line 10 of Algorithm 1 and stored in Mem_{U}.

FIG. 4 shows an example of the extend operation at line 7 of

Algorithm 1 and how update matrix U is extended and stored on Q_{U}. The PE initializes an index counter for Memo and a vector of elements to zeros, and loops over all elements of a Boolean pattern matrix (P) received from FIFO channel Q_{P}. If an element of matrix P is true, an element of the update matrix in Mem_{U} is stored to the vector location indexed by the counter, and the index counter is increased by 1. Otherwise, the corresponding element of the vector is skipped and kept as zero. Once VL iterations have been passed, the vector is stored on Q_{U}.
20 4. OpenCL Implementation

FSCHOL takes advantage of the loop unrolling technique provided by OpenCL for parallel implementation of vectorized operations. The PEs are implemented as autorun modules. An autorun module starts executing automatically and does not need to be launched by a host. Therefore, the Intel OpenCL offline compiler for FPGA does not need to generate the communication logic between the host and PEs, which reduces logic utilization and enables additional performance optimizations. However, load and store modules are launched explicitly by the host since they need to access off-chip memory.

Most storage units are implemented as FIFO channels rather than RAMs, where random access is not required. However, for Mem_{U} there is no choice other than using RAMs. Although using shift registers would be more efficient in terms of hardware complexity, the number of elements to be stored is unknown at the compile time and depends on dimensions of F_{S}. Additionally, no intermediate data is written and read to/from off-chip memory.
The datapath has VL single-precision floating-point numbers, and the arithmetic submodules perform VL operations in parallel. Table II shows the size of storage units for each PE. Dimensions of FIFOs and RAM blocks are represented as Depth×Width and Rows×Columns, respectively. Parameter WL is the word length of the data format (e.g., 32 bits for single-precision floating-point).

TABLE II
The required size (bits) for each storage unit

| Unit | Size |
|---|---|
| Q_{U} (2×) | [(N + M) × (N + M) × VL] × VL × WL |
| Q_{F} (2×) | |
| Q_{F, PE} (2×) | |
| Mem_{U} (2×) | [N × VL] × [N × VL] × WL |

There are three tunable parameters: VL, N, and M. Parameter M and N are used to scale the design to support arbitrary sizes for frontal and update matrices based on the maximum supernode size (i.e., the maximum number of consecutive columns with the same sparsity pattern) and the maximum number of nonzero elements among all columns of the factor matrix, respectively. The total number of required DSPs for the FPGA kernel with two PEs is equal to 7×VL+5.

According to Table II, total required size for the storage units is (8N²+6M²+12M×N)×VL²×WL bits.
5. Performance-optimized Model for Determining Design Parameters

It is important to provide a guideline to derive design parameters (VL, N, and M) to minimize the runtime subject to the available on-chip resources and the characteristics of the input matrices.

The runtime (R) is formulated as

$$R = \frac{N}{F \times P \times U} ,$$

where N, F, P, and U are the number of floating-point operations (FLOPs) to factorize a matrix using Algorithm 1, the clock frequency, the computational parallelism, and the spatial-temporal utilization factor, respectively. U is a statistical metric that measures the average occupation (in both space and time) of the available computation resources in a computing device for performing the FLOPs of a given algorithm. Therefore, U is the average ratio of effective computational parallelism per clock cycle ranging from 0 to 1. N is an algorithmic parameter and depends on dimensions and the sparsity structure of the input matrix. P is determined by the total number of utilized DSP units calculated as 7×VL+5. Therefore, R can also be expressed as

$$R = \frac{{N}_{Ops}}{F \times ( 7 \times VL + 5 ) \times U} = \frac{α}{7 \times VL + 5} \qquad Equation 1$$

where

$$α = \frac{{N}_{Ops}}{F \times U}$$

is an empirical term that lumps the algorithm- and implementation-specific terms N_{Ops}, F, and U. Note that α is introduced mainly to simply the formulation and can be treated as a constant when determining the optimal architectural parameters.

The constrained optimization problem is defined as

$$\begin{matrix}minimize & R ( VL ) = \frac{α}{7 \times VL + 5} & \\ subject to & {f}_{1} ( VL ) \leq {C}_{1} , & {f}_{2} ( VL , M , N ) \leq {C}_{2} , \\ & M = ⌈ \frac{{C}_{3}}{VL} ⌉ , & N = ⌈ \frac{{C}_{4}}{VL} ⌉\end{matrix} \qquad Equation 2$$

where f₁(VL)=7×VL+5 and C₁ are the total number of required and available DSP block, respectively, f₂(VL,M,N)=(8N²+6M²+12M×N)×VL²×WL and C₂ are the total required and available RAM size, respectively, C₃ is the maximum supernode size (i.e., maximum number of consecutive columns of the factor matrix with the same sparsity pattern), and C₄ is the maximum number of nonzero elements among all columns of the factor matrix. For the total available RAM size (C₂), one must consider a margin from the values reported in the FPGA device datasheet to consider for RAM resources used for the glue and control logics.

Based on

$$R ( VL ) = \frac{α}{7 \times VL + 5} ,$$

to minimize the runtime, VL should be maximized. The constrained optimization problem defined as Equation 2 has an analytical solution as following.
1) Derive the first constraint for VL from f₁(VL)≤C₁.
2) Derive the second constraint for VL by using

$$M = ⌈ \frac{{C}_{3}}{VL} ⌉ and N = ⌈ \frac{{C}_{4}}{VL} ⌉$$

in f₂(VL,M,N)≤C₂.
3) Now there are two ranges of values for VL. The maximum value of VL is determined from the tighter constraint.

4) Using calculated VL, the values of

$$N and M are found from = ⌈ \frac{{C}_{3}}{VL} ⌉ and N = ⌈ \frac{{C}_{4}}{VL} ⌉ .$$

B. Scheduling Algorithm
1. Concepts

The main challenges involved in co-designing the scheduling algorithm with the proposed hardware architecture for the FPGA kernel stem from two perspectives. On the one hand, as the objective of the scheduling algorithm is to minimize the amount of off-chip memory access on the FPGA device, the impact of workload scheduling on the amount of off-chip memory access must be accurately modeled based on the specific architecture of the FPGA kernel. On the other hand, the scheduling algorithm may be generic enough to be able to adapt to the FPGA kernel implementations in various computational parallelism on different FPGA devices.

A scheduling algorithm is proposed and implemented that intelligently assigns the update and factorization operations (update and factorize) to PEs to minimize on-chip memory requirements with no off-chip memory access for the storage of intermediate results. The main goal of the algorithm is to pipeline the dependency among a child supernode C and its parent supernode S to avoid storing the update matrix of supernode C. Therefore, the algorithm assigns operation update (S,C) immediately after operation factorize(C). In this order, when supernode C is factorized and its update matrix is produced, the update matrix is consumed by supernode S at the same PE to reduce the on-chip storage requirements and reduce communications among different PEs. The pseudo-code is provided only for PE1 as it is the same for PE2. Note that the algorithm works for both supernodal and potentially multifrontal Cholesky factorization.

2. Details

In Algorithm 2, list nc is used to keep track of the number of children that each supernode is already updated by. Line 3-6 works on supernodes with no child. Since they do not have any dependency, it is only needed to initialize the frontal matrix F with elements of the matrix A and immediately factorize the supernode. Once a supernode with no dependency is factorized in a PE, its update matrix is ready to update its parent supernode. Therefore, the supernode ID is pushed to PE's queue. Then, the supernode ID is popped from the queue, and the corresponding parent supernode is updated. Suppose a supernode is updated by all of its children. In that case, it is ready to be factorized, and the resulting update matrix is used for updating the parent supernode in the consequent job assigned to this PE. Otherwise, the queue would be empty, and the algorithm starts with lines 3-6. During this process, if a parent supernode needs to be updated in a different PE than it was updated, the configuration bits of the job assigned to the other PE is updated to let the PE know that it has to send the intermediate frontal matrix to the inter-module FIFO (Q_{F}).

Algorithm 2: The scheduling algorithm

| | Input: | | The list of (super)nodes with no child (T), the | | |
|---|---|---|---|---|---|
| | | | list of parents for each (super)node (P), and the | | |
| | | | list of the no. of children of each (super)node | | |
| | | | (NC). | | |
| | Output: | | The assignment of update and factorize | | |
| | | | operations to each PE. | | |
| 1 | initialize list nc to zeros to keep track of the no. | | | | |
| | children that each (super)node is updated by; | | | | |
| 2 | initialize two single-element queues Q₁ and Q₂ as | | | | |
| | empty to store the ready (super)node to be updated or | | | | |
| | factorized: | | | | |
| 3 | while the top (super)node is not factorized do | | | | |
| 4 | \| | if Q₁ is empty then | | | |
| 5 | \| | \| | S = T[0]; | | |
| 6 | \| | \| | assign update(S, —) to PE₁; | | |
| 7 | \| | \| | remove T[0] from T; | | |
| 8 | \| | \| | p = P[S]; | | |
| 9 | \| | \| | push(p, Q₁); | | |
| 10 | \| | else | | | |
| 11 | \| | \| | S = pop(Q₁); | | |
| 12 | \| | \| | indicate (super)node S is being updated; | | |
| 13 | \| | \| | indicate vector V_{U} should be read from Q_{U}; | | |
| 14 | \| | \| | if nc[S] is equal to zero then | | |
| 15 | \| | \| | \| | if (super)node S was updated in this PE | |
| | \| | \| | \| | then | |
| 16 | \| | \| | \| | \| | indicate vector V_{F} should be read from |
| | \| | \| | \| | \| | Q_{F,PE}; |
| 17 | \| | \| | \| | else | |
| 18 | \| | \| | \| | \| | indicate vector V_{F} should be read from |
| | \| | \| | \| | \| | Q_{F}; |
| 19 | \| | \| | \| | \| | update the job bits of the assigned job to |
| | \| | \| | \| | \| | other PE by indicating it should write |
| | \| | \| | \| | \| | the intermediate vector V_{F} to Q_{F}; |

| 20 | \| | \| | \| | end |
|---|---|---|---|---|
| 21 | \| | \| | end | |
| 22 | \| | \| | nc[S] + +; | |
| 23 | \| | \| | if nc(S) is equal to NC[S] then | |
| 24 | \| | \| | \| | assign(p[S]) to PE₁; |
| 25 | \| | \| | \| | push(S, Q₁); |

| | | | |
|---|---|---|---|
| 26 | \| | \| | end |

| | | |
|---|---|---|
| 27 | \| | end |
| | \| | /* similar approach for PE₂ */ |

| | |
|---|---|
| 28 | end |

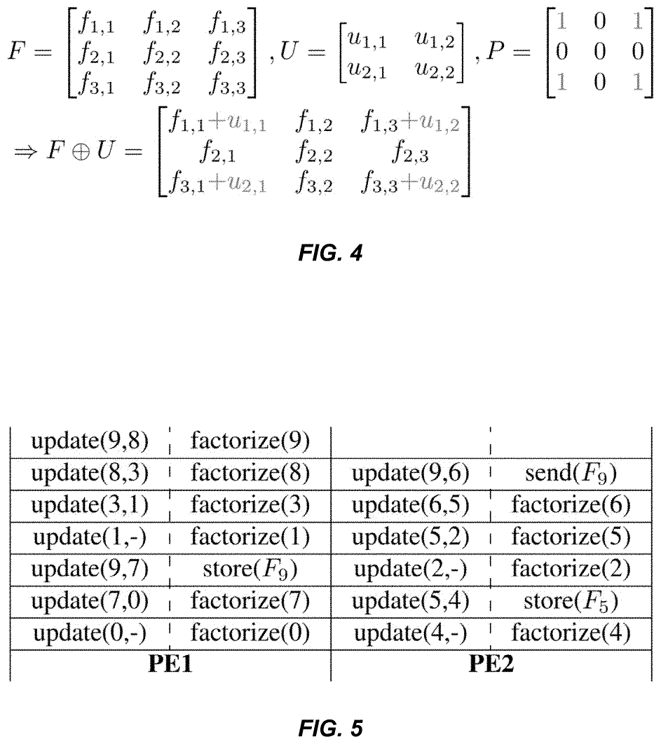

FIG. 5 illustrates an output of a scheduling algorithm for the supernodal elimination tree in FIG. 1C. The scheduling algorithm is implemented as a part of the host code. As an example, the algorithm is applied to the elimination tree illustrated in FIG. 1C. The ordered list of supernodes is T=[0,4,1,2]. Lists P and NC are [7,3,5,8,5,6,9,9,9,−1] and [0,0,0,1,0,2,1,1,1,3], respectively. Value−1 in list P shows that the last node is reached. The output of this example is shown in FIG. 5, with time increasing from bottom to top.

### IV. Evaluation

A. Setup

The performance and energy efficiency of FSCHOL is evaluated in terms of runtime (s) and energy consumption (J). To evaluate the design, a set of matrices are selected from the publicly available SuiteSparse Matrix Collection (formerly known as the University of Florida Sparse Matrix Collection and described in T. A. Davis and Y. Hu, “The University of Florida Sparse Matrix Collection,” TOMS, vol. 38, no. 1, pp. 1-25, 2011), a set of sparse matrices in real applications. The characteristics of the matrices are summarized in Table III including matrix dimensions (the number of rows and columns are equal), the density percentage calculated from

$$\frac{No . of Nonzero Elements}{Matriz Size} \times 100 ,$$

and the number of supernodes.

The data format in this design is single-precision floating-point (32-bit). FSCHOL is developed and implemented using Intel FPGA SDK for OpenCL with Quartus Prime Pro 20.1. FSCHOL is compared with CPU and GPU versions of CHOLMOD (described in Y. Chen et al., “Algorithm 887: CHOLMOD, Supernodal Sparse Cholesky Factorization and Update/Downdate,” TOMS, vol. 35, no. 3, pp. 1-14, 2008).

TABLE III
The specification of matrices chosen from
the SuiteSparse Matrix Collection

| Matrix | # Supernodes | # Rows | Density (%) |
|---|---|---|---|
| nd3k | 87 | 9,000 | 4.049 |
| Trefethen_20000b | 3,678 | 19,999 | 0.139 |
| smt | 856 | 25,710 | 0.567 |
| thread | 923 | 29,736 | 0.503 |
| pdb1HYS | 1,149 | 36,417 | 0.328 |
| nd24k | 625 | 72,000 | 0.554 |
| Fault_639 | 30,305 | 638,802 | 0.007 |
| Emilia_923 | 43,270 | 923,136 | 0.005 |
| bone010 | 44,319 | 986,703 | 0.005 |

As mentioned before, the supernodal multifrontal method decomposes the sparse Cholesky factorization into a series of dense factorizations. These dense factorizations rely on dense BLAS and LAPACK libraries. Therefore, to improve the performance of the CHOLMOD library on CPU, Intel Math Kernel Library (Intel MKL) is used instead of single-threaded BLAS and LAPACK routines. Intel MKL is a set of highly optimized, threaded, and vectorized math functions that maximize the performance of Intel's processors.

The performance of the CPU implementation of CHOLMOD is measured on a dual-socket Intel Xeon E5-2637 v3 CPU with an effective bandwidth of 51 GB/s per socket, and the GPU implementation of CHOLMOD on an NVIDIA Tesla V100 GPU, one of the most powerful data center GPUs for accelerating HPC. An embodiment of FSCHOL is evaluated on an Intel Stratix 10 GX FPGA Development Board. Table IV summarizes the specifications of the CPU system, the GPU device, and the FPGA board used in the evaluation.

TABLE IV
Specification of the CPU system, the GPU device,
and the FPGA board used in the evaluation

| Hardware Platform | Specification |
|---|---|
| Intel Xeon E5- | 15M Cache, 3.50 GHz Clock Frequency, 4 Cores, |
| 2637 v3 CPU | 68 GB/s Memory Bandwidth |
| NVIDIA Tesla | 16 GP HBM2, 640 Tensor Cores, 5120 CUDA |
| V100 GPU | Cores, 1245-1380 MHz Clock Frequency, 900 GB/s |
| | Memory Bandwidth |
| Intel Stratix 10 | 5760 DSPs, 229 Mb M20K, 15 Mb MLAB, 15 GB/s |
| GX FPGA Board | Memory Bandwidth |

### B. Evaluation Results

1. Performance Comparison with CPU and GPU Implementations

The architectural parameters for implementing the FPGA kernel are VL=128, N=4, and M=2. The FPGA kernel runs at 236 MHz. Table V shows the resource utilization for the implemented FPGA kernel.

TABLE V
Resource utilization on Intel Stratix 10 GX with
VL = 128, N = 4, and M = 2

| Resource | ALUTs | FFs | RAMs | DSPs |
|---|---|---|---|---|
| Utilization | 315,858 | 634,846 | 6,844 | 901 |
| | 17% | 17% | 58% | 16% |

Table VI shows the performance comparison of FSCHOL in terms of runtime in seconds with the GPU version of CHOLMOD and the CPU version of CHOLMOD enhanced with Intel MKL library for implementing the supernodal multifrontal Cholesky factorization algorithm. The lower runtime shows higher performance. According to Table VI, the CPU implementation outperforms the GPU version of CHOLMOD since algorithms and applications with low arithmetic computation and complex memory handling are more efficient to be mapped on CPUs than on GPUs. Also, the GPU runs with the error correction code (ECC) turned on at the base clock speed. One can further boost the GPU performance using a boost clock speed with ECC turned off at the cost of much higher power consumption and random bit errors. The base clock speed is chosen with ECC to evaluate the sustainable performance achievable in a scientific computing environment. The GPU cannot work at a boost clock speed permanently or for a long time. Moreover, turning off ECC compromise the results probabilistically where accurate results are necessary for scientific computing.

TABLE VI
Runtime (second) comparison between the FPGA implementation
of FSCHOL and the CPU and GPU implementations of CHOLMOD

| | CHOLMOD | | |
|---|---|---|---|
| Matrix | CPU | GPU | FSCHOL |
| nd3k | 0.31 | 0.99 | 0.05 |
| Trefethen_20000b | 3.56 | 4.82 | 1.30 |
| smt | 0.26 | 1.84 | 0.31 |
| thread | 0.47 | 2.04 | 0.34 |
| pdb1HYS | 0.36 | 2.40 | 0.42 |
| nd24k | 10.49 | 12.02 | 0.36 |
| Fault_639 | 33.00 | 49.26 | 10.89 |
| Emilia_923 | 55.57 | 62.90 | 15.57 |
| bone010 | 23.28 | 58.48 | 15.88 |

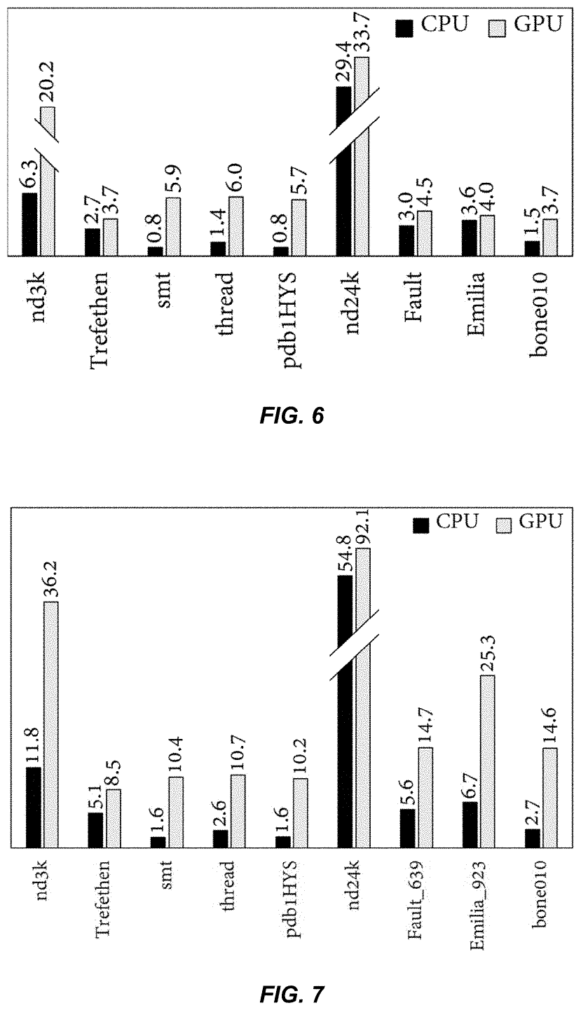

FIG. 6 shows the performance improvement of the proposed framework over the CPU and GPU implementations for corresponding the matrix. FSCHOL improves the performance of CPU and GPU versions of CHOLMOD by 0.8×−29.4× and 3.7×−33.7×, respectively. The mean of FSCHOL performance improvement over CPU and GPU implementations is 5.5× and 9.7×, respectively. For matrices where FSCHOL is less performant than the CPU implementation of CHOLMOD, the sparsity pattern is less structured and there are too many supernodes that cause performance degradation, while for matrices with a very structured sparsity pattern and a small number of nonzero supernodes compared to the matrix dimension, FSCHOL significantly improves the performance as the performance scales with the number of supernodes and the matrix size.
2. Performance Comparison with the State-of-the-art FPGA Implementation

The work in Y. Sun et al., “Sparse Cholesky Factorization on FPGA Using Parameterized Model,” Mathematical Problems in Engineering, vol. 2017 (referred to herein as Sun) implemented the multifrontal Cholesky factorization algorithm on a Xilinx Virtex-7FPGA VC709 evaluation board with a 28 nm FPGA device. In contrast, FSCHOL is implemented on an Intel Stratix 10 GX FPGA development board with a 14nm FPGA device. For a fair comparison, the performance numbers of Sun are normalized to the 14 nm technology node using the scaling factor of delay=1/S, where S=28/14 nm, commonly used in the existing literature. In addition, the performance of the FSCHOL solution is evaluated based on the same matrices used in Sun.

Table VII shows the performance comparison of FSCHOL in terms of normalized runtime in seconds with the work in Sun for implementing the multifrontal Cholesky factorization algorithm. The original performance results of Sun are also shown in Table VII. Similarly, the lower runtime shows the higher performance, and the numbers in parentheses show the performance improvement of FSCHOL with respect to the corresponding matrix. The evaluation results show that the proposed FSCHOL solution outperforms the reference design in terms of performance by 11.7× on average across the three different benchmarks.

TABLE VII
Runtime (second) comparison between the FPGA implementation
of FSCHOL and the reference work Sun

| Matrix | Sun | Sun scaled to 14 nm | FSCHOL (Speedup) |
|---|---|---|---|
| nd3k | 1.96 | 0.98 | 0.05 (19.6×) |
| Trefethen_20000b | 3.94 | 1.97 | 1.30 (1.5×) |
| nd24k | 10.12 | 5.06 | 0.36 (14.1×) |

The performance improvement of FSCHOL over the work in Sun is primarily due to the elimination of off-chip memory access for buffering intermediate results as a result of the software-hardware co-design methodology. Specifically, the scheduling algorithm implemented in the host program is tailored to the proposed hardware architecture of the FPGA kernel to offload the computational workloads of different supernodes in an optimized order that maximizes the data reuse of intermediate results, thus avoids unnecessary off-chip memory access.
3. Energy Efficiency Comparison with CPU and GPU Implementations

The average power consumption of the Intel Stratix 10 GX development board is measured using the Power Monitor tool in the Board Test System (BTS) application provided by Intel during FPGA kernel execution. BTS measures the supply voltage and the drawn current of the entire FPGA board by reads values from on-board sensors.

For the power measurement of the CPU, the likwidpowermeter tool from Likwid is used to access the Running Average Power Limit (RAPL) counters on the Intel CPU. The RAPL interface is controlled through MSR registers. For the power measurement of the GPU, the POWER query option of NVIDIA System Management Interface (nvidia-smi) tool is used.

Table VIII summarizes the energy consumption (J) of different implementations calculated from multiplying the runtime (s) and the power consumption (W).

TABLE VIII
Energy consumption (J) comparison between
the FPGA implementation of FSCHOL and the
CPU and GPU implementations of CHOLMOD

| | CHOLMOD | | |
|---|---|---|---|
| Matrix | CPU | GPU | FSCHOL |
| nd3k | 13 | 39 | 1 |
| Trefethen_20000b | 146 | 244 | 29 |
| smt | 11 | 72 | 7 |
| thread | 19 | 80 | 8 |
| pdb1HYS | 15 | 95 | 9 |
| nd24k | 430 | 723 | 8 |
| Fault_639 | 1353 | 3523 | 240 |
| Emilia_923 | 2279 | 8665 | 342 |
| bone010 | 954 | 5108 | 349 |

FIG. 7 shows the energy consumption reduction factor of the proposed framework over the CPU and GPU implementations for the corresponding matrix. FSCHOL reduces the energy consumption of the CPU and GPU implementations by 1.6×−54.7× and 8.5×−92.1×, respectively. The mean of FSCHOL energy reduction over CPU and GPU implementations are 10.3× and 24.7×, respectively. Since the work in Sun did not provide any result on power or energy consumption, such a comparison is not provided.

### V. Computer System

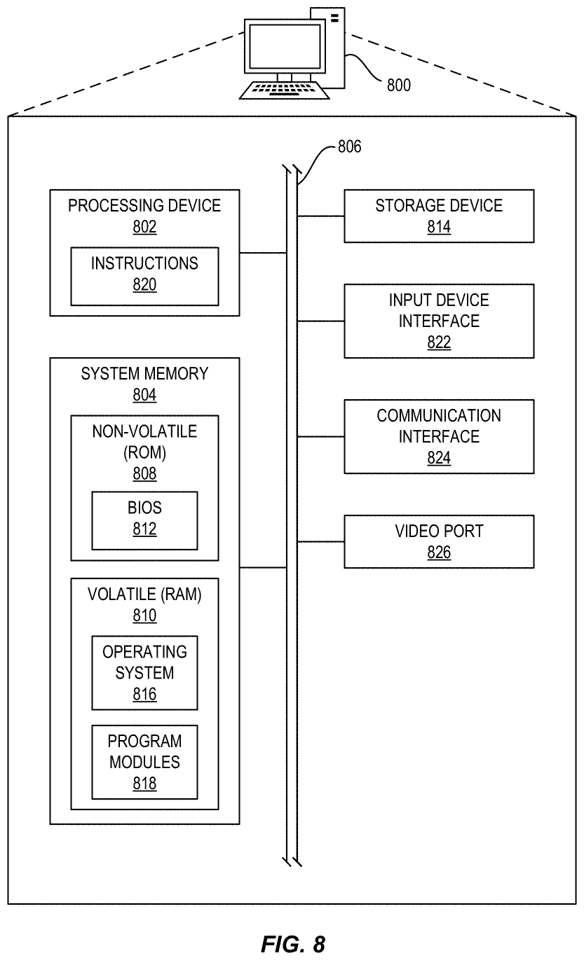

FIG. 8 is a block diagram of a computer system 800 suitable for implementing the proposed framework (e.g., FSCHOL) according to embodiments disclosed herein. The computer system 800 comprises any computing or electronic device capable of including firmware, hardware, and/or executing software instructions that could be used to perform any of the methods or functions described above, such as acceleration of sparse Cholesky factorization. In this regard, the computer system 800 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 800 in this embodiment includes a processing device 802 or processor, a system memory 804, an FPGA 828, and a system bus 806. In some embodiments, the processing device 802 represents one or more commercially available or proprietary general-purpose processing devices, such as a microprocessor, central processing unit (CPU), or the like. More particularly, the processing device 802 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. According to some embodiments, the processing device 802 includes an FPGA. The processing device 802 is configured to execute processing logic instructions for performing the operations and steps discussed herein. According to some embodiments, the processing device 802 performs the actions of the host program, as disclosed herein.

In this regard, the various illustrative logical blocks, modules, and circuits described in connection with the embodiments disclosed herein may be implemented or performed with the processing device 802, which may be a microprocessor, FPGA, a digital signal processor (DSP), an application-specific integrated circuit (ASIC), or other programmable logic device, a discrete gate or transistor logic, discrete hardware components, or any combination thereof designed to perform the functions described herein. Furthermore, the processing device 802 may be a microprocessor, or may be any conventional processor, controller, microcontroller, or state machine. The processing device 802 may also be implemented as a combination of computing devices (e.g., a combination of a DSP and a microprocessor, a plurality of microprocessors, one or more microprocessors in conjunction with a DSP core, or any other such configuration).

The FPGA 828 may implement the FPGA kernel architecture and perform the FPGA kernel actions as disclosed herein. For example, the FPGA kernel actions of the FPGA 828 may be scheduled by the host program implemented by the processing device 802, as disclosed herein.

The system memory 804 may include non-volatile memory 808 and volatile memory 810. The non-volatile memory 808 may include read-only memory (ROM), erasable programmable read-only memory (EPROM), electrically erasable programmable read-only memory (EEPROM), and the like. The volatile memory 810 generally includes random-access memory (RAM) (e.g., dynamic random-access memory (DRAM), such as synchronous DRAM (SDRAM)). A basic input/output system (BIOS) 812 may be stored in the non-volatile memory 808 and can include the basic routines that help to transfer information between elements within the computer system 800.

The system bus 806 provides an interface for system components including, but not limited to, the system memory 804, the FPGA 828, and the processing device 802. The system bus 806 may be any of several types of bus structures that may further interconnect to a memory bus (with or without a memory controller), a peripheral bus, and/or a local bus using any of a variety of commercially available bus architectures.

The computer system 800 may further include or be coupled to a non-transitory computer-readable storage medium, such as a storage device 814, which may represent an internal or external hard disk drive (HDD), flash memory, or the like. The storage device 814 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 816 and any number of program modules 818 or other applications can be stored in the volatile memory 810, wherein the program modules 818 represent a wide array of computer-executable instructions corresponding to programs, applications, functions, and the like that may implement the functionality described herein in whole or in part, such as through instructions 820 on the processing device 802. The program modules 818 may also reside on the storage mechanism provided by the storage device 814. As such, all or a portion of the functionality described herein may be implemented as a computer program product stored on a transitory or non-transitory computer-usable or computer-readable storage medium, such as the storage device 814, volatile memory 810, non-volatile memory 808, instructions 820, and the like. The computer program product includes complex programming instructions, such as complex computer-readable program code, to cause the processing device 802 to carry out certain steps necessary to implement the functions described herein.

An operator, such as the user, may also be able to enter one or more configuration commands to the computer system 800 through a keyboard, a pointing device such as a mouse, or a touch-sensitive surface, such as the display device, via an input device interface 822 or remotely through a web interface, terminal program, or the like via a communication interface 824. The communication interface 824 may be wired or wireless and facilitate communications with any number of devices via a communications network in a direct or indirect fashion. An output device, such as a display device, can be coupled to the system bus 806 and driven by a video port 826. Additional inputs and outputs to the computer system 800 may be provided through the system bus 806 as appropriate to implement embodiments described herein.

For example, the computer system 800 may be communicatively coupled to one or more application computer systems, which utilize a Cholesky factorization provided by the computer system 800 for any of a variety of applications.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

1. A computer system for Cholesky factorization, the computer system comprising:
a field-programmable gate array (FPGA), the FPGA comprising an FPGA hardware architecture comprising a plurality of hardware processing elements, the FPGA configured to perform kernel operations comprising:
performing a supernodal multifrontal algorithm for Cholesky factorization of a matrix, wherein the supernodal multifrontal algorithm for Cholesky factorization comprises factorize and update operations performed by the processing elements, and
providing the Cholesky factorization of the matrix; and
an electronic processor, the electronic processor communicatively coupled to the FPGA, the electronic processor implementing a host program, the host program configured to perform host operations comprising:
identifying dependencies among computation nodes in an elimination tree derived from the matrix, and
scheduling the processing elements to perform the factorize and update operations, using temporal parallelism, based on the dependencies.

2. The computer system of claim 1, wherein the computer system implements the Cholesky factorization of the matrix for one of:
signal processing, wherein the Cholesky factorization is implemented in an adaptive filtering algorithm,
finance, wherein the Cholesky factorization is implemented in portfolio optimization or risk management,
engineering, wherein the Cholesky factorization is implemented in structural analysis,
computer graphics, wherein the Cholesky factorization is implemented in mesh deformation or smoothing,
optimization, wherein the Cholesky factorization is implemented in convex optimization,
machine learning, wherein the Cholesky factorization is implemented in a machine learning algorithm, or
statistics, wherein the Cholesky factorization is implemented in the estimation of a covariance matrix, a regression analysis, or a calculation of a Mahalanobis distance.

3. The computer system of claim 1, wherein the electronic processor comprises a central processing unit (CPU), wherein the CPU is communicatively coupled to the FPGA via a bus.

4. The computer system of claim 1, wherein each hardware processing element comprises:
vector addition and matrix extension hardware modules responsible for the update operation; and
sqrt, vector division, outer product, and vector subtraction hardware modules responsible for the factorize operation.

5. The computer system of claim 1, wherein the computer system avoids off-chip memory access for intermediate data in performing the supernodal multifrontal algorithm for Cholesky factorization.

6. The computer system of claim 1, wherein the plurality of processing elements are communicatively coupled to each-other via at least one first-in-first-out (FIFO) channel.

7. The computer system of claim 1, further comprising:
a respective load module for each of the processing elements, wherein each processing element is communicatively coupled to its respective load module via at least one FIFO channel; and
a respective store module for each of the processing elements, wherein each processing element is communicatively coupled to its respective store module via at least one FIFO channel.

8. The computer system of claim 7, wherein depths of the FIFO channels are determined by an offline compiler.

9. The computer system of claim 1, wherein the scheduling the processing elements to perform the factorize and update operations comprises:
assigning, to each processing element, an update operation for a parent node immediately after a factorize operation for a child node.

10. The computer system of claim 1, wherein the matrix is sparse.

11. A method of Cholesky factorization, the method implemented by:
a field-programmable gate array (FPGA), the FPGA comprising an FPGA hardware architecture comprising a plurality of hardware processing elements, and
an electronic processor, the electronic processor communicatively coupled to the FPGA, the electronic processor implementing a host program,
wherein the method comprises:
performing, by the FPGA, a supernodal multifrontal algorithm for Cholesky factorization of a matrix, wherein the supernodal multifrontal algorithm for Cholesky factorization comprises factorize and update operations performed by the processing elements;
identifying, by the host program, dependencies among computation nodes in an elimination tree derived from the matrix;
scheduling, by the host program, the processing elements to perform the factorize and update operations, using temporal parallelism, based on the dependencies; and
providing the Cholesky factorization of the matrix.

12. The method of claim 11, further comprising implementing the Cholesky factorization of the matrix for one of:
signal processing, wherein the Cholesky factorization is implemented in an adaptive filtering algorithm,
finance, wherein the Cholesky factorization is implemented in portfolio optimization or risk management,
engineering, wherein the Cholesky factorization is implemented in structural analysis,
computer graphics, wherein the Cholesky factorization is implemented in mesh deformation or smoothing,
optimization, wherein the Cholesky factorization is implemented in convex optimization,
machine learning, wherein the Cholesky factorization is implemented in a machine learning algorithm, or
statistics, wherein the Cholesky factorization is implemented in the estimation of a covariance matrix, a regression analysis, or a calculation of a Mahalanobis distance.

13. The method of claim 11, wherein the electronic processor comprises a central processing unit (CPU), wherein the CPU is communicatively coupled to the FPGA via a bus.

14. The method of claim 11, wherein each hardware processing element comprises:
vector addition and matrix extension hardware modules responsible for the update operation; and
sqrt, vector division, outer product, and vector subtraction hardware modules responsible for the factorize operation.

15. The method of claim 11, wherein the method avoids off-chip memory access for intermediate data in performing the supernodal multifrontal algorithm for Cholesky factorization.

16. The method of claim 11, wherein the plurality of processing elements are communicatively coupled to each-other via at least one first-in-first-out (FIFO) channel.

17. The method of claim 11, wherein the method is further implemented using:
a respective load module for each of the processing elements, wherein each processing element is communicatively coupled to its respective load module via at least one FIFO channel; and
a respective store module for each of the processing elements, wherein each processing element is communicatively coupled to its respective store module via at least one FIFO channel.

18. The method of claim 11, further comprising determining, by an offline compiler, depths of the FIFO channels.

19. The method of claim 11, wherein the scheduling the processing elements to perform the factorize and update operations comprises:
assigning, to each processing element, an update operation for a parent node immediately after a factorize operation for a child node.

20. The method of claim 11, wherein the matrix is sparse.
